(19) United States
(12) Patent Application Publication
(10) Pub. No.: US 2023/0021956 A1
(43) Pub. Date: Jan. 26, 2023

(54) LENS-FREE INFRARED MULTISPECTRAL IMAGING DEVICE AND MANUFACTURING METHOD

(71) Applicant: COMMISSARIAT A L'ENERGIE ATOMIQUE ET AUX ENERGIES ALTERNATIVES, Paris (FR)

(72) Inventors: Mathieu DUPOY, Grenoble Cedex 9 (FR); Emerick LORENT, Grenoble Cedex 9 (FR)

(73) Assignee: COMMISSARIAT A L'ENERGIE ATOMIQUE ET AUX ENERGIES ALTERNATIVES, Paris (FR)

(21) Appl. No.: 17/786,099

(22) PCT Filed: Dec. 16, 2020
(86) PCT No.: PCT/EP2020/086546

§ 371 Date: Jun. 16, 2022

(30) Foreign Application Priority Data
Dec. 19, 2019 (FR) FR1914926

(51) Int. Cl. G01N 21/3563

(52) U.S. Cl. CPC G01N 21/3563

(57) ABSTRACT

The invention provides a lens-free infrared imaging device (1) intended to image a sample (2), comprising at least one light source (3, 3a, 3b) configured to emit a light according to several wavelengths of the infrared range, and at least one sensor (4) configured to detect some of the light emitted having interacted with the sample, said sensor comprising a plurality of pixels (41), the device being characterised in that the sensor (4) is configured to detect a reflective part of the light emitted. The invention also provides a method for manufacturing this device.

### TECHNICAL FIELD

The present invention relates to the field of lens-free infrared optical imaging. It will have a particularly advantageous, but non-limiting, application in biological tissue imaging.

### STATE OF THE ART

In numerous fields of application, like agribusiness, medicine and health control, the detection and identification of chemical or biochemical compounds are necessary with the aim of detecting a contamination or also making a diagnosis. Infrared (IR) spectrometry is a widely used analytical technique for detecting and identifying such chemical or biochemical compounds.

In order to produce an image of a sample to be analysed, a known solution consists of mapping the sample via a microscope associated with a polychromatic IR source and a Fourier transform IR (FTIR) spectrometer. Such a system makes it possible to scan the sample and to obtain multispectral images of spatial resolution of around 10 μm. A disadvantage of this type of solution is that analysing a sample surface area of a few mm² or a few cm² is long. The field of view of the sample to be imaged is subsequently limited. Such a system is furthermore complex, expensive and bulky.

The emergence of quantum cascade lasers (QCL) makes it possible to produce a plurality of monochromatic IR sources, covering the spectral range of the polychromatic IR sources. Subsequently, it is no longer necessary to use an FTIR spectrometer to spectrally analyse the light having interacted with the sample. A detector which is infrared-sensitive suffices to quantify the intensity of the light transmitted or diffused by the sample, for each of the wavelengths of the QCLs.

Moreover, by using a plurality of detectors forming a pixel matrix, typically an IR imager comprising bolometers, it becomes possible to achieve multispectral imaging without an FTIR spectrometer. Such a solution makes it possible to produce wide field of view and spatially resolved images, without scanning the object. Multispectral imaging in the mid-infrared is subsequently quicker. Furthermore, such an instrumentation comprising QCLs and an IR imager can be relatively compact. This makes it possible to design portable IR multispectral imaging devices.

The document, “Biomedical applications of mid-infrared quantum cascade lasers—a review, K. Isensee et al., The Analyst, vol. 143, no. 24, pp. 5888-5911, 2018” disclosed IR imaging devices for observing samples, in particular biological samples. Section 5 of this document, entitled “5. Microspectroscopy of tissue thin sections” mentions, in particular, the association of QCL and bolometers within an IR multispectral imaging system. This makes it possible to observe a sample, in the form of a thin strip, by having it between the light source based on the QCLs and the bolometer-based image sensor. A wide-field image can thus be obtained without scanning the object. This makes it possible to reduce the acquisition time of the image. The analysis flow rate by IR multispectral imaging is therefore considerably increased.

Such a device therefore makes it possible to obtain spatially resolved spectral information without scanning the sample. It makes it possible to obtain over a wide field of view, a plurality of images of the sample, each image being a function of the spectral response of the sample to the light emitted by the different QCLs. Such a device makes it possible, for example, to perform a diagnosis on biological tissues in order to determine cancerous zones and healthy zones.

A disadvantage of this device is that it requires a preparation of the sample in the form of a thin strip. A sample sampling on an object to be imaged is therefore necessary. This sampling is invasive. This does not make it possible to take in-vivo medical measurements or in-situ quality controls, i.e. directly on the object.

There is therefore a need consisting of providing a non-invasive, compact, IR multispectral device, making it possible to produce wide-field images with a reduced acquisition time.

The present invention aims to propose such a device, at least partially overcoming the disadvantages of the current solutions mentioned above.

Another aim of the present invention relates to a method for manufacturing a non-invasive IR multispectral imaging device.

Other aims, characteristics and advantages of the present invention will appear upon examining the following description and the accompanying drawings. It is understood that other advantages can be incorporated. In particular, certain characteristics and certain advantages of the device can apply mutatis mutandis to the method, and conversely.

### SUMMARY

To achieve these aims, the present invention proposes a lens-free infrared imaging device intended to image a sample or an object, said device comprising at least one light source configured to emit light according to several wavelengths of the infrared range, and at least one sensor configured to detect some of the light emitted having interacted with the sample or the object, said sensor comprising a plurality of pixels.

Advantageously, the sensor is configured to detect a reflected part of the light emitted, in particular along detection directions having opposite directions to the emitting directions of the light emitted by the light source.

In this way, it is not necessary to shape the sample to be imaged. The device advantageously makes it possible to image a sample or at least one part of an object without sampling, non-invasively. It suffices, for example, to place the device in the immediate proximity of the sample to be imaged, to obtain a plurality of images according to several wavelengths of the IR range.

This device also makes it possible to produce these images with a reduced acquisition time. Each image is indeed acquired directly in one single acquisition, contrary to a system based on the mapping principle, requiring an acquisition in each point of the image to be produced.

This device further advantageously has no optical lenses to form the image on the sensor. This makes it possible to considerably simplify the instrumentation. The cost of the device is decreased. This further makes it possible to reduce the bulk of the device. The compactness of the device is improved.

It is further no longer necessary to provide a space between the IR light source and the IR imager to introduce the sample. The bulk of such a device is also reduced.

The present invention also relates to a method for using such a reflective IR spectral imaging device, wherein the device is in contact with or in the immediate proximity of a zone to be imaged of the sample, such that the distance separating said zone to be imaged and the sensor is less than 200 μm. This makes it possible to maximise the flow of reflected light collected by the sensor. Such a use is particularly advantageous for applications for diagnosing biological tissues, for example in the field of histopathology to differentiate healthy tissues from tumorous tissues.

The present invention also relates to a method for manufacturing such a device, wherein the light source is a secondary source formed by a photonic chip comprising a plurality of light emitters in the form of passive extraction structures, said passive extraction structures being coupled with a primary light source configured to emit light according to several wavelengths of the IR range. This method comprises at least the following steps:
Providing the primary light source,
Forming the photonic chip intended to reemit, at an emission face, the light emitted by the primary source,
Providing a sensor comprising a plurality of pixels capable of detecting, on a detection face, some of the light emitted by the primary light source,
Assembling the photonic chip to the sensor such that the emission and reception faces face one same side
Coupling the primary light source with the passive extraction structures of the photonic chip.

### BRIEF DESCRIPTION OF THE FIGURES

The aims, objectives, as well as the characteristics and advantages of the invention will best emerge from the detailed description of embodiments of the latter, which are illustrated by the following accompanying drawings, wherein:

FIG. 1A schematically illustrates, as a perspective view, an IR multispectral imaging device according to an embodiment of the present invention.

FIG. 1B is an enlargement of a part of the device illustrated in FIG. 1A.

FIG. 2 schematically illustrates, as a cross-section, an IR multispectral imaging device according to an embodiment of the present invention.

FIG. 3 presents a calculation of the light flow reflected by a sample and received by a pixel of an IR imager, according to the distance between the pixel and the sample.

FIG. 4 schematically illustrates, as a perspective view, a photonic chip according to an embodiment of the present invention.

FIG. 5 schematically illustrates, as a top view, a relative arrangement of the pixels of a detection matrix and emitters of an emission matrix, according to an embodiment of the present invention.

FIG. 6A schematically illustrates, as a cross-section, a passive extraction structure facing a waveguide, formed on a photonic chip, according to an embodiment of the present invention.

FIG. 6B schematically illustrates, as a cross-section, a passive extraction structure facing a waveguide, formed on a photonic chip, according to another embodiment of the present invention.

FIG. 7 schematically illustrates, as a cross-section, a matrix IR sensor and a photonic chip, stacked on one another according to an embodiment of the present invention.

FIG. 8A schematically illustrates, as a top view, a detection matrix according to an embodiment of the present invention.

FIG. 8B schematically illustrates, as a top view, an emission matrix according to an embodiment of the present invention.

FIG. 8C schematically illustrates, as a top view, a superposition of an emission matrix and a detection matrix according to an embodiment of the present invention.

FIG. 9A schematically illustrates, as a cross-section, an assembly of a first substrate comprising passive extraction structures with a second substrate comprising waveguides, so as to form a photonic chip according to an embodiment of the present invention.

FIG. 9B schematically illustrates, as a cross-section, the photonic chip obtained after assembly, such as illustrated in FIG. 9A.

FIGS. 10A to 10H schematically illustrate steps for manufacturing passive extraction structures according to an embodiment of the present invention.

FIGS. 11A to 11D schematically illustrate steps for manufacturing waveguides according to an embodiment of the present invention.

The drawings are given as examples and are not limiting of the invention. They constitute schematic principle representations intended to facilitate the understanding of the invention and are not necessarily to the scale of practical applications. In particular, the dimensions of the different structures (extraction, waveguide, pixel) are not representative of reality.

### DETAILED DESCRIPTION

Before starting a detailed review of embodiments of the invention, it is reminded that, optionally, the invention comprises at least any one of the following optional characteristics which can be used in association or alternatively.

According to an example, the light source has an emission face intended to emit light in the direction of the sample of be imaged and the sensor has a detection face intended to receive the part reflected by the sample of the light emitted by the light source, said emission and detection faces facing one same side of the device.

According to an example, the at least one light source comprises a primary source configured to emit light according to several wavelengths of the infrared range, coupled with a secondary source, configured to reemit said light in a plurality of emission directions, the emission face being located at the secondary source and the primary source being moved outside of an emission zone of the emission face.

According to an example, the light source and the sensor are stacked on one another.

According to an example, the light source and the sensor are arranged relative to one another, such that the light source is closer to the sample than the sensor, in operation.

According to an example, the light source and the sensor are arranged relative to one another, such that the sensor is closer to the sample than the light source, in operation.

According to an example, the light source and the sensor are arranged relative to one another, such that the sensor and the light source are located at a substantially identical distance from the sample, in operation.

According to an example, the pixels of the sensor are formed by bolometers.

According to an example, the light source is formed at least partially by a photonic chip comprising a plurality of light emitters.

According to an example, the light emitters are arranged in the form of an emission matrix.

According to an example, the pixels of the sensor are arranged in the form of a detection matrix.

According to an example, the photonic chip is superposed to the sensor.

According to an example, the light emitters are alternated with the pixels of the sensor, in projection in a stack direction of the photonic chip and of the sensor.

According to an example, the light emitters surround the pixels of the sensor, in projection in a stack direction of the photonic chip and of the sensor.

According to an example, the photonic chip forms at least partially, the secondary source.

According to an example, the light emitters are passive extraction structures coupled with the primary source. The passive extraction structures advantageously make it possible to avoid electronics (active structure). This makes it possible to increase the compactness of the device. This makes it possible to limit, even remove, a local heating at the light emitters, which is a major challenge for wavelengths of the infrared range.

According to an example, the photonic chip comprises waveguides configured to couple the passive extraction structures with the primary light source.

According to an example, the photonic chip comprises waveguides configured to guide the light emitted by the primary source to the passive extraction structures.

According to an example, the photonic chip has a thickness of between 100 microns and 2 mm. Such a thickness, advantageously less than or equal to 2 mm, makes it possible to maintain at least one light source, typically the secondary light source, sufficiently close to the sensor. This makes it possible to limit or avoid optical losses between the secondary source and the sensor. This also makes it possible to improve the spatial resolution of this lens-free device.

According to an example, the passive extraction structures each have at least one facet inclined by an angle of between 30° and 60° relative to the emission face.

According to an example, the facets of the passive extraction structures are facing the waveguides and are configured to reflect the light exiting the waveguides according to the plurality of emission directions, so as to form extraction mirrors.

According to an example, the primary light source comprises a plurality of quantum cascade lasers QCL.

According to an example, the formation of the photonic chip comprises:
Forming the passive extraction structures protruding from a first face of a first silicon-based substrate, by etching of said substrate,
Forming waveguides facing the extraction structures, said waveguides being configured to guide the light emitted by the primary light source to the extraction structures.

According to an example, the waveguides are formed directly on the first face of the first silicon-based substrate, in at least one layer made of a material different from silicon, and the passive extraction structures are formed in said at least one layer.

According to an example, the waveguides are formed on a second face of a second substrate, and the second substrate is assembled to the first substrate, such that the waveguides are facing the extraction structures of the first substrate.

According to an example, the method further comprises a thinning of the second substrate from a face opposite the second face.

According to an example, the passive extraction structures are etched so as to each have at least one facet inclined by an angle of between 30° and 60° relative to the first face.

According to an example, a metal deposition is performed on each of said at least one facet, so as to form extraction mirrors.

The present invention has, as a preferable field of application, a platform for diagnosing biological tissues by non-invasive optical analysis in the spectral range of the mid-infrared (MIR).

The device according to the present invention, combining, in an embodiment, a series of QCLs and an intermediate lens-free IR detector, arranged so as to enable a reflective IR multispectral imaging, in particular makes it possible to perform such diagnoses non-invasively.

The device according to the present invention can advantageously be manufactured using conventional micro-manufacturing technologies, in particular silicon technologies developed in microelectronic sectors.

Below, the term “absorption” or its equivalents refers to the phenomenon by which the energy from an electromagnetic wave is transformed into another energy form, for example in the form of heat.

Below, the term “diffusion” or its equivalents refers to the phenomenon by which a propagation medium produces a distribution, in numerous directions, of the energy from an electromagnetic wave, light energy, for example.

Below, the term “reflection” or its equivalents refers to the phenomenon of reemission from a surface of an incident light radiation, in one or more directions having directions opposite the incident direction. In the present invention, a surface is considered as reflective as soon as it reemits at least some of the incident light radiation. The reflective surface can be characterised by a reflection factor of between 0 and 1. The reflection can be specular (a reflection direction), or diffuse (several reflection directions).

By an object or a material which is “transparent at a given wavelength” or simply “transparent”, this means an object or a material which lets at least 90% of the light intensity of the light having this wavelength pass. For example, a silicon wafer having a thickness less than or equal to 1 mm is transparent to a light radiation having a wavelength of between 6 μm and 10 μm. The optical losses by absorption of silicon are less than 5 dB/cm over this wavelength range.

The incident light radiation(s) is/are emitted by one or more corresponding primary source(s). The light emitted by these sources belongs to the infrared range and preferably to the mid-infrared range, i.e. for a wavelength range of between 5 μm and 11 μm. These primary sources typically comprise a plurality of monochromatic or quasi-monochromatic lasers, each having a main wavelength. The main wavelength is the only wavelength emitted by a monochromatic laser, or the wavelength mainly emitted by a quasi-monochromatic laser.

The device according to the invention further comprises a “sensor”. This sensor is presented typically in the form of a pixel-forming IR photodetector matrix. The terms “sensor” and “imager” are therefore here used as synonyms.

By a material A-“based” structural element, layer, this means a structural element, a layer comprising this material A only or this material A and possibly other materials, for example doping elements or alloy elements. Thus, if a transparent substrate is referenced as being “silicon-based”, this means that it can be formed only of silicon or of silicon and possibly other materials, for example impurities or germanium.

In the present application, the diameter, the width and the length are taken in a direction transverse to the stack axis. The thickness or the depth are taken along the stack axis.

In the present description, the expression “lens-free” means that the device does not comprise optical elements in the form of lens over the light beam path between the emission face of the light source and the sensor.

The present invention can be used for the imaging of samples, in particular samples of a biological nature, and in particular, in vivo. The IR multispectral imaging device can thus be applied directly against the skin of a patient for diagnosis needs. The emission face of the source is preferably positioned so as to be substantially parallel to the surface of the sample. The main emission direction of the light source is thus substantially perpendicular to the surface of the sample.

Preferably, the light source is configured to emit, via each emitter, light into a portion of the space, around a main emission direction. In particular, the portion of the space can be a conical portion, the axis of which is the main emission direction. The main emission direction can be perpendicular to the emission face of the light source. Generally, the direction of the light beams emitted has a majority component along the main emission direction, and a minority component along a direction perpendicular to the main emission direction.

Advantageously, the emitters of the light source have parallel main emission directions.

Preferably, each pixel of the sensor is configured to receive light from a portion of the space, around a main detection direction. The main detection direction can be perpendicular to the detection face of the sensor. Generally, the direction of the light beams detected, coming from the reflection, has a majority component along the main detection direction and a minority component along a direction perpendicular to the main detection direction.

Advantageously, the pixels of the sensor have parallel main detection directions.

Preferably, the main detection directions and the main emission directions are parallel. Advantageously, the main detection directions and/or the main emission directions are perpendicular to the surface of the sample.

According to an aspect of the invention, the detection directions and the emission directions have opposite directions. This does not mean that the directions are parallel, as the light, both emitted and reflected, will generally cover a certain portion of the space. However, their main components have opposite directions.

According to the invention, the device is configured such that the light exits the device in the direction of the sample and such that some of this light, reflected, again enters into the device after having interacted with the sample.

According to the embodiments, the sensor and the light source are superposed. This extends from a relative arrangement of these two components, at the very least concerning the emission and detection faces. However, the superposition does not necessarily mean that, in projection along a stack axis, the light emitters and the pixels are superposed. In particular, according to this projection, the emitters can surround the pixels, or conversely.

It is specified that in the scope of the present invention, the term “on”, “surmounts”, “covers” or “underlying” or their equivalents do not mean “in contact with”. Thus, for example, a photonic chip covering an imager does not compulsorily mean that these are directly in contact with one another, but this means that the photonic chip covers at least partially the imager, by being either directly in contact with it, or by being separated from it by at least one other layer or at least one other element.

Unless otherwise specifically specified, technical characteristics described in detail for a given embodiment can be combined with the technical characteristics described in the context of other embodiments described as an example and in a non-limiting manner. In particular, the number of light emitters or extraction structures, the different patterns of the emission or reception matrices and/or the different forms of the elements of the device illustrated in the figures can be combined so as to form another embodiment which is not necessarily illustrated or described. Such an embodiment is clearly not excluded from the invention.

The terms “substantially”, “around”, “about” mean “at almost 10%” or, when this relates to an angular orientation, “at almost 10°” and preferably “at almost 5°”. Thus, a direction substantially normal to a plane means a direction having an angle of 90±10° relative to the plane.

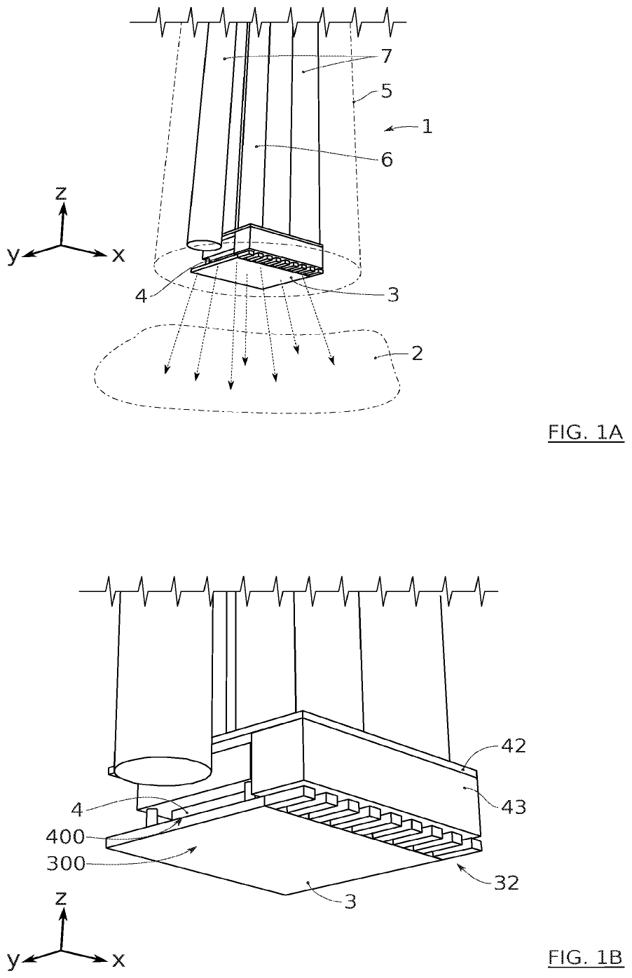

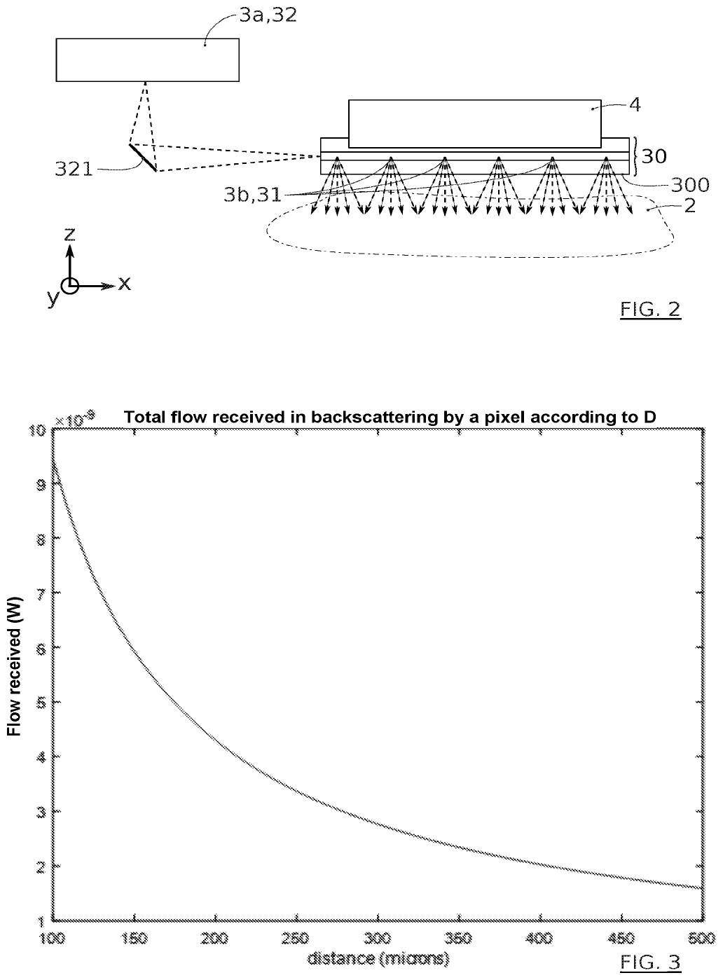

A first example of a device according to the invention will now be described in reference to FIGS. 1A, 1B and 2.

As illustrated in the diagram of FIG. 1A, the reflective IR imaging device 1 is intended to come into the immediate proximity or in contact with the sample 2 to be imaged. The sample 2 is, for example, a biological tissue or an agribusiness product.

The device 1 typically comprises a body 5 housing a light source 3 and an imager 4. The body 5 can be presented as a cylindrical shape, such as illustrated in FIG. 1A, or more generally, as any shape having good ergonomics, for example so as to facilitate the handling of the device 1.

The body 5 can comprise peripheral components, such as an electric supply or an electric supply connection 6, or also at least one optical fibre 7. Such an optical fibre 7 in particular makes it possible to view the zone of the sample 2 to be imaged. It can be connected to a camera. This makes it possible to improve the positioning precision of the device against the sample, for example at a carcinoma potential directly on a patient.

The body 5 comprises, at its distal end, the light source 3 and the imager 4. FIG. 1B shows an enlarged view of the distal end of the device 1. The light source 3 and the imager 4 can typically be superposed. For example, the light source 3 and the imager 4 form a stack along z, with the light source 3 located closer to the distal end of the device 1, and the imager 4 located against the light source 3, slightly withdrawn from the distal end of the device 1. The light source 3 has an emission face 300 intended to emit the light. The imager 4 has a detection face 400 intended to receive the light reflected by the sample 2. To enable such a reflective imaging, the emission and detection faces 300, 400 face one same side, towards the sample 2 to be analysed.

The imager 4 is configured to detect light in the IR or MIR range. It typically comprises IR bolometers distributed so as to form a pixel matrix. The imager 4 can be associated with control electronics 42, and/or a regulator 43 intended to thermalise the IR bolometers.

The light source 3 can be a primary light source 3a, or a secondary light source 3b. Such as illustrated in FIG. 2, the device can typically comprise a primary light source 3a coupled with light emitters 31 forming the secondary light source 3b. The light emitters 31 are, in this case, passive extraction structures. According to a non-illustrated possibility, the light emitters 31 are light-emitting diodes (LED) and directly form a primary light source 3a.

Such as illustrated in FIG. 2, and preferably, the device comprises a primary light source 3a coupled with a secondary light source 3b. This makes it possible to move the primary light source 3a. This makes it possible to reduce the bulk of the light source 3 at the distal end of the device.

The primary light source 3a can typically comprise quantum cascade lasers QCL 32 emitting according to wavelengths of between 5 μm and 10 μm. In particular, the primary light source 3a comprises a plurality of QCLs configured to each simultaneously emit a different wavelength. Each of the QCLs 32 can be associated with a plurality of light emitters 31 of the secondary light source 3b. The emission surface 300 is thus increased. This makes it possible to more broadly and/or more evenly illuminate the zone of the sample 2 to be imaged.

In this case, the light emitters 31 are preferably passive extraction structures coupled with the QCLs 32 via mirrors 321, optical fibres or waveguides 312. The light emitters 31 and the waveguides 312 are typically grouped together within a photonic chip 30. In this embodiment, the photonic chip 30 is placed on an imager 4 formed by a bolometer matrix. The distance separating the photonic chip 30 from the sensitive part of the bolometers, or also the distance separating the emission face 300 from the detection face 400, is about a few tens of microns, for example of between 10 μm and 200 μm. The light coming from the QCLs 32 is guided by the waveguides 312 to the passive extraction structures forming the light emitters 31, then directed towards the sample 2 by the light emitters 31. The light emitters 31 typically form an emission matrix configured to evenly illuminate the zone of the sample 2 to be imaged. The sample 2 will typically absorb, reflect or diffuse the light emitted or reemitted by the light emitters 31. The bolometer matrix placed behind the photonic chip 30 is configured to receive the reflected part of the light. Advantageously, the photonic chip 30 is silicon-based. Silicon is transparent to IR and MIR wavelengths. This makes it possible to place the photonic chip 30 in front of the imager 4, without shielding the bolometers. The photonic chip 30 can be based on another material which is transparent to IR and MIR wavelengths, for example germanium-based.

FIG. 3 shows a result of collected flow reflected by a pixel (bolometer) of 25 μm on the side for an illumination of 10 mW/cm² of a Lambertian reflective object having an albedo equal to 1. For a distance of 250 μm between the pixel and the object, the pixel receives a reflected light flow having an optical power of around 3 nW. Such a power is fully detectable by an IR imager pixel, in particular of the IR bolometer type. As illustrated in FIG. 3, the lower the distance is between the zone of the sample 2 to be imaged and the imager 4, the greater the reflected light flow collected by the imager 4 is. Furthermore, the spatial resolution of a lens-free device 1 is more than the distance separating the zone of the sample 2 to be imaged and the imager 4 is low. Thus, advantageously, the photonic chip 30 has a thickness along z less than or equal to 300 μm, preferably less than or equal to 250 μm, and preferably less than or equal to 200 μm.

The device 1 is preferably used directly in contact with or in the immediate proximity of the zone of the sample 2 to be imaged. In particular, the emission face 300 can be placed against the zone to be imaged. In this way, the distance separating the zone to be imaged and the sensor can be less than or equal to 250 μm, preferably less than 200 μm. This makes it possible to maximise the reflected light flow collected by the sensor.

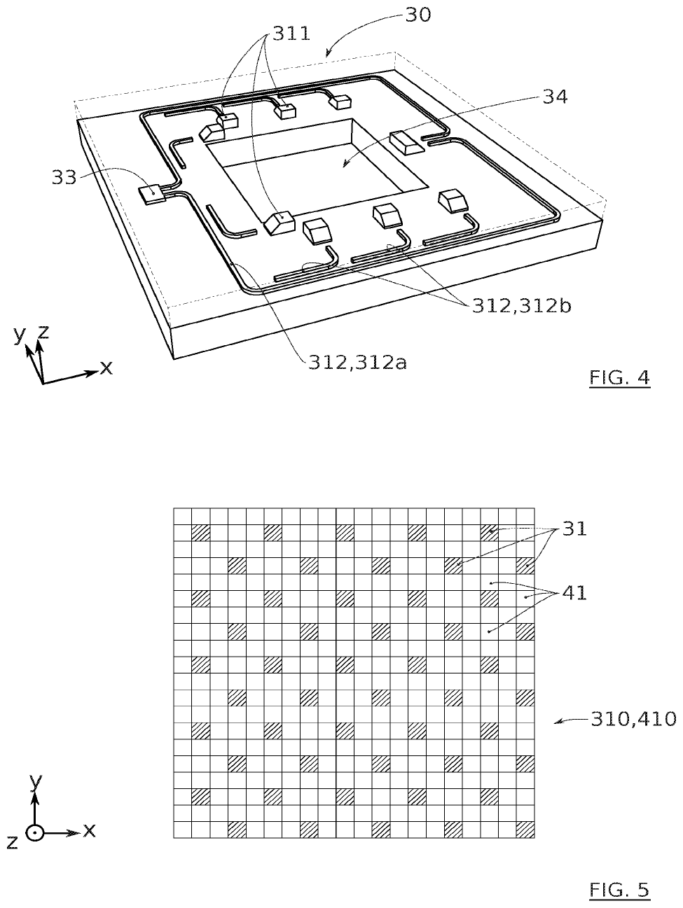

FIG. 4 illustrates an example of a photonic chip 30. In this example, the passive extraction structures 311 are arranged at the perimeter of an opening 34 of the photonic chip 30. This opening 34 can be configured to house the imager 4 at least partially. Thus, the emission matrix surrounds the detection matrix, in projection along z. The opening 34 makes it possible to let the beams reflected by the sample pass, towards the imager 4 (not illustrated). These reflected beams typically have a main detection direction along the axis z, of direction +z.

The passive extraction structures 311 are configured to reemit incident beams towards the sample (not illustrated). These incident beams typically have a main emission direction along the axis z, of direction −z.

The passive extraction structures 311 are preferably coupled with waveguides 312, 312a, 312b, and preferably each of the passive extraction structures 311 is individually coupled with one single waveguide 312b. According to an example, the photonic chip 30 comprises an optical input 33 intended to receive the light emitted by the primary source 3a. This optical input 33 serves main waveguides 312a transporting the light to all of the passive extraction structures 311. Secondary waveguides 312b can be each associated with a particular passive extraction structure 311. The secondary waveguides 312b can, for example, be coupled with the main waveguides 312a by an evanescent coupling, such as illustrated in FIG. 4. The use of a plurality of waveguides can make it possible to pass more optical power. This also makes it possible to illuminate the sample according to the different wavelengths of the QCLs, simultaneously.

The passive extraction structures 311 presented in this example can be replaced by light emitters 31, for example LEDs. In this case, it is not necessary to use waveguides 312. Combinations of different types of light emitters 31, for example LEDs and passive extraction structures 311, can be considered. According to a possibility, some of the light emitters 31 are, for example, LEDs, and some of the other light emitters 31 are, for example, passive extraction structures 311. In this case, waveguides 312 can be associated with the LEDs and with the passive extraction structures 311 so as to transport the light emitted in each point of the emission matrix.

FIG. 5 presents another example of distributing light emitters 31. In this example, the emission and detection matrices 310, 410 are at least partially superposed, in projection along z. Thus, the light emitters 31 are each surrounded by pixels 41 of the imager 4. This makes it possible to obtain an emission surface, in the plane of the sheet, relatively homogenous and even. The distribution of the pixels 41 and of the light emitters 31 is preferably performed so as to obtain a good compromise between the emission surface and the detection surface. Pixels 41 can be masked by light emitters 31. This makes it possible to simplify the design of the bolometer matrix, while preserving an acceptable detection surface.

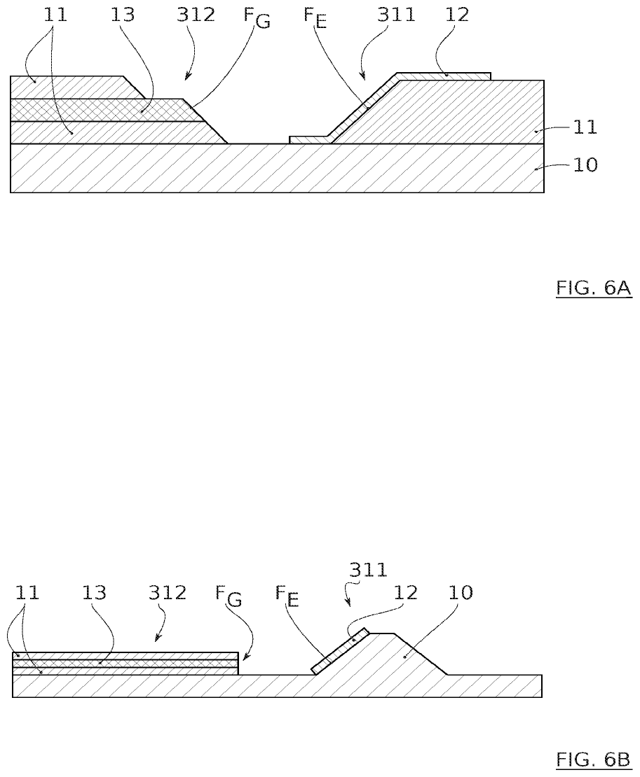

FIGS. 6A and 6B illustrate two particular embodiments of a passive extraction structure 311 and of a waveguide 312. The waveguides 312 are configured to guide a light of a wavelength of between 5 μm and 11 μm. In the example of FIG. 6A, the waveguide 312 and the extraction structure 311 are formed in a germanium- or silicon-germanium SiGe-based layer 11, on a silicon Si-based substrate 10. The structuring of the waveguide 312 and of the extraction structure 311 can thus be done according to a so-called monolithic approach. This makes it possible to form the waveguide 312 and the extraction structure 311 directly on one same substrate 10.

The waveguide 312 typically comprises a cladding formed by the layer 11 and a core 13 formed within the layer 11. The cladding is, for example, made of SiGe having a germanium content of around 20%. The core 13 is, for example, made of Ge or of SiGe having a germanium content of around 40%. The waveguide 312 can have an output facet F_{G} inclined relative to the basal plane of the substrate 10. Such an inclined facet can typically be obtained by tetramethylammonium hydroxide (TMAH)- or potassium hydroxide (KOH)-based wet etching. Other waveguide materials can be used, for example and in a non-limiting manner: CaF2, BaF2, ZnS, ZnSe. CdSe, SiN, AlN, Ta2O5, TiO2, ZrO2, amorphous carbon, chalcogenide.

The extraction structure 311 is here formed directly in the layer 11, for example made of SiGe having a germanium content of around 20%. The extraction structure 311 typically has a facet F_{E} inclined relative to the basal plane of the substrate 10. The tilt angle can be of between 30° and 60° relative to the basal plane, for example of about 45° or of 55°. The facet F_{E} is located facing the output facet F_{G} of the waveguide 312. The facet F_{E} is configured to reflect the light exiting the waveguide 312 in emission or reemission directions having a main component substantially normal to the basal plane. The facet F_{E} is preferably metallised by a metal layer 12. The facet F_{E} of the extraction structure 311 typically forms an extraction mirror.

In the example of FIG. 6B, the extraction structure 311 is formed in the silicon Si-based substrate 10, and the waveguide 312 is formed in a germanium- or silicon-germanium SiGe-based layer 11. The structuring of the waveguide 312 can thus be done on a second substrate independent from the substrate 10 comprising the extraction structure 311, according to a so-called heterogenic approach. In this example, the waveguide 312 also comprises a cladding formed by the layer 11 and a core 13 formed within the layer 11, as above. The waveguide 312 can have an output facet F_{G} normal to the basal plane of the substrate 10. Such a normal facet can typically be obtained by dry etching, for example by plasma. The extraction structure 311 is here formed directly in the substrate 10. It also has a facet F_{E} facing the output facet F_{G} of the waveguide 312. This facet F_{E} is inclined and preferably metallised, as above.

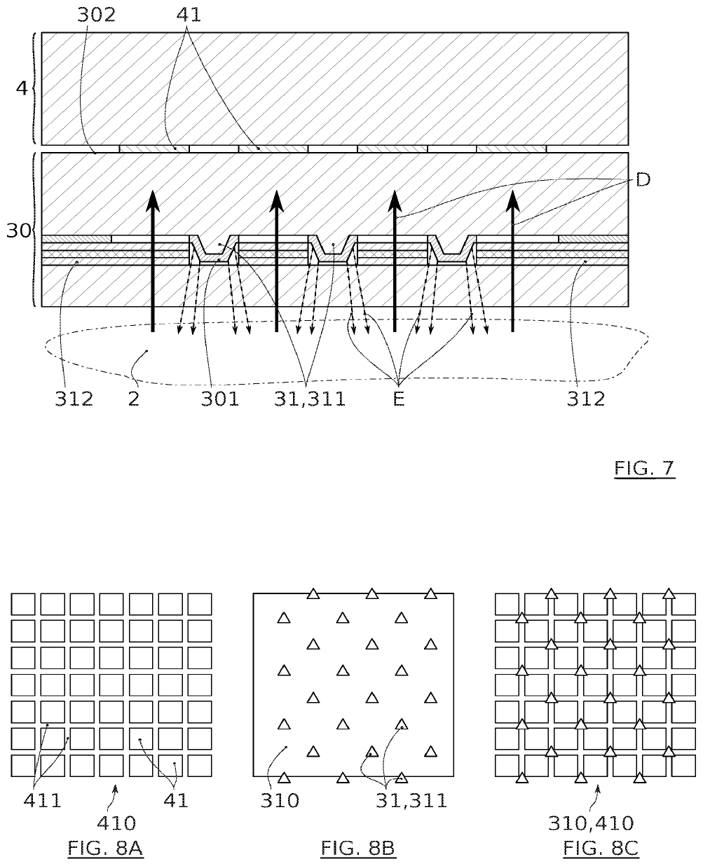

FIG. 7 presents a device comprising a photonic chip 30 having a face 301 intended to come into the proximity of or in contact with a sample 2, typically a biological sample. The device further comprises an imager 4 comprising a plurality of pixels 41, for example in the form of a microbolometer matrix. The photonic chip 30 has a face 302 opposite the face 301. This face 302 is here intended to come into the proximity of or in contact with the pixels 41 of the imager 4.

The photonic chip 30 is preferably configured to illuminate the sample 2 in the mid-infrared homogenously in emission directions E. The photonic chip 30 is typically transparent in the mid-infrared so as to let the part of the light backscattered or reflected by the sample 2 pass to the pixels 41, in detection directions D.

The photonic chip 30 comprises, for example, extraction structures 311 and waveguides 312 arranged as described above in reference to FIG. 6B.

FIGS. 8A to 8C present distributions of pixels 41 and of light emitters 31 making it possible to avoid or to limit the shielding of the pixels 41 by the light emitters 31. FIG. 8A presents a detection matrix 410 where the pixels 41 are separated from one another by inter-pixel zones 411. FIG. 8B presents an emission matrix 310 where the light emitters 31, for example extraction structures 311 forming micro-mirrors, are arranged so as to coincide with the inter-pixel zones 411 of the detection matrix 410, once superposed. FIG. 8C illustrates a superposition of the emission and detection matrices 310, 410. The micro-mirrors are preferably located at the intersections of the inter-pixel zones 411. This makes it possible to place waveguides between the micro-mirrors and between the superposed intersections of the inter-pixel zones 411 (not illustrated). Thus, the pixels 41 of the imager are not shielded by the micro-mirrors and/or the waveguides of the photonic chip.

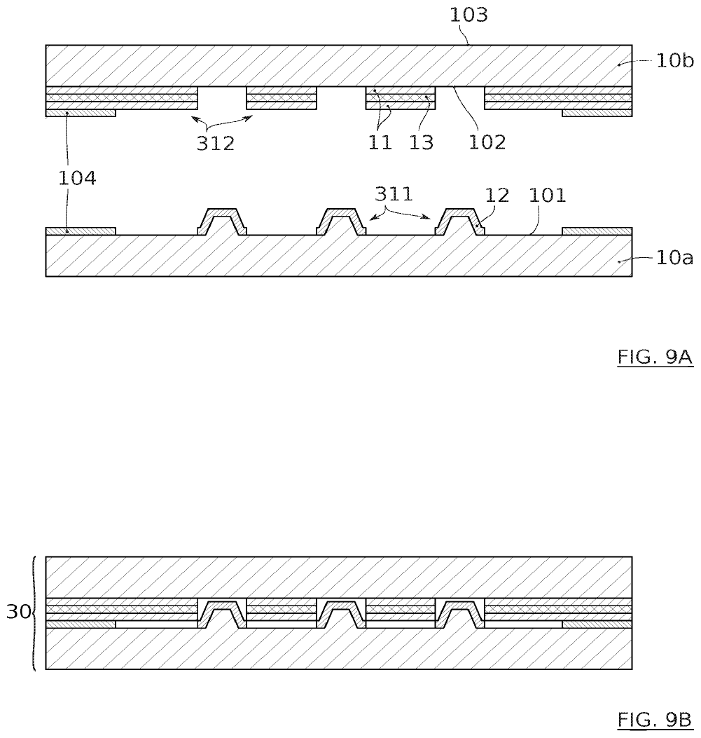

FIGS. 9A, 9B illustrate a principle of forming the photonic chip according to a heterogenic approach. According to this approach, the extraction structures 311 are formed on a first face 101 of a first silicon-based substrate 10a, and the waveguides 312 are formed on a second face 102 of a second silicon-based substrate 10b. Below, the first substrate 10a supporting the extraction structures 311 in the form of micro-mirrors is called “mirror wafer”. The second substrate 10b supporting the waveguides 312 is called “waveguide wafer”. The photonic chip 30 is then formed by assembly of the waveguide and mirror wafers at their faces 102, 101.

The microelectronics technologies make it possible to produce these wafers and to assemble them compactly with an integration precision which is sufficient for forming the photonic chip 30.

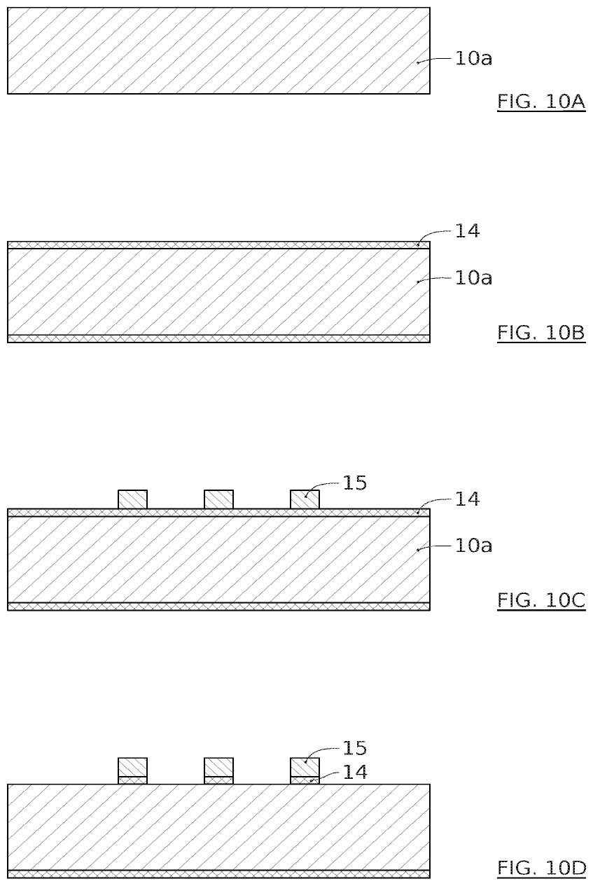

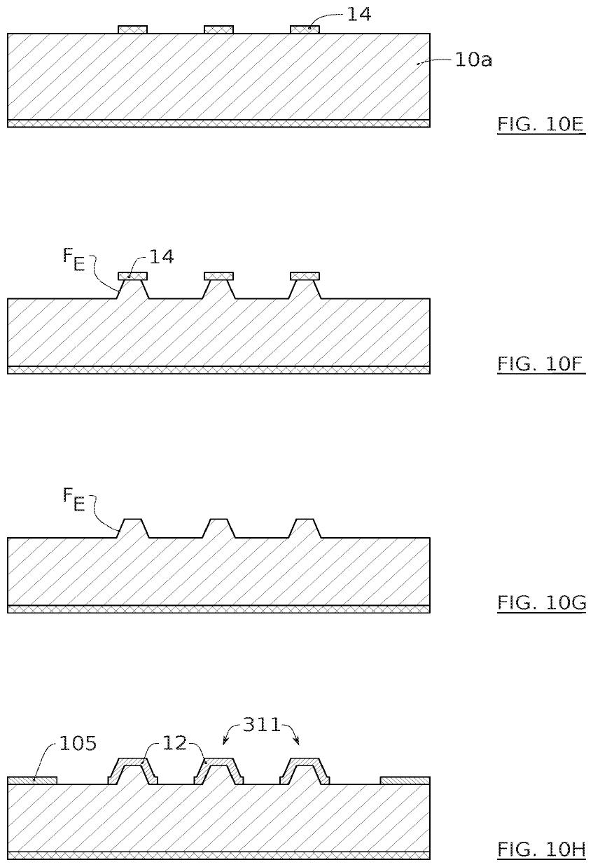

FIGS. 10A to 10H present steps for manufacturing the mirror wafer. FIG. 10A illustrates the provision of a silicon (100) substrate 10a. The crystalline orientation of the substrate is in particular chosen according to the anisotropic etching chemistries used for etching the facets of the mirrors. A hard mask 14 typically silicon nitride-based, is deposited on the substrate 10a, for example by low pressure chemical vapour deposition (LPCVD) (FIG. 10B). Photosensitive resin patterns 15 are then formed by photolithography (FIG. 10C). The hard mask 14 is etched (FIG. 10D) and the resin is removed (FIG. 10E).

The substrate 10a is then etched (FIG. 10F) by anisotropic etching of the Si in an alkaline solution, for example tetramethylammonium hydroxide (TMAH)-, or potassium hydroxide (KOH)-, or pyrocatechol and water (EDP)-based. The inclination of the facets F_{E} obtained after etching can vary according to the crystallographic orientation of the substrate, the nature of the hard mask and the etching solution used. Typically, tilt angles of 54.7° or of 45° can be achieved. This technique makes it possible to obtain very smooth facets. Other techniques make it possible to obtain inclined facets. A lithography technique commonly called “grey tone” consists of making the energy dose vary during lithography of the resin being used for the etching mask. The resin pattern has, after development, a gradient which is transferred into the substrate by dry etching, for example by RIE (Reactive Ion Etching).

The height of the extraction structures thus formed can be chosen according to the height of the waveguides produced on the waveguide wafer and/or the width of the inter-pixel zones. This height is typically of between 9 μm and 11 μm.

The hard mask 14 is then removed (FIG. 10G) and the facets F_{E} are metallised (FIG. 10H). The metallisation of the facets F_{E} can be done by depositing a titanium-gold Ti/Au bilayer. The Ti/Au deposition has a thickness typically of between 50 nm and 500 nm. The metallisation can be done by means of a stencil or more conventionally, by photolithography and etching. The metallisation can alternatively be done by creeping. The technique of depositing by creeping consists of depositing the material, for example metal, on the structure, for example the facets, that are sought to be covered. An annealing then makes it possible to achieve a vitreous transition of the material such that it can mould the shape of the structure. The metal ensures the reflective function of the micro-mirrors. It further advantageously makes it possible to facilitate the mechanical assembly of the mirror wafer with the waveguide wafer during a gluing by thermocompression.

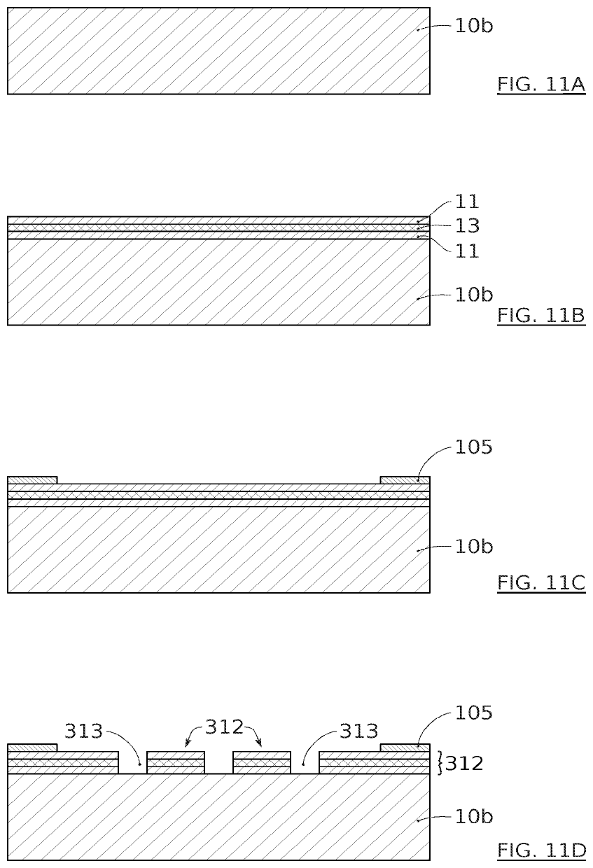

FIGS. 11A to 11D present steps for manufacturing the waveguide wafer. FIG. 11A illustrates the provision of a silicon substrate 10b. An epitaxial succession makes it possible to form the layers 11 and 13 respectively forming the cladding and the core of the waveguides (FIG. 11B). The layers 11 are, for example, formed by epitaxy of SiGe at 40% of Ge and the layer 13 is, for example, formed by epitaxy of Ge. The thicknesses deposited are typically of about 3 μm for Ge and of 3 to 5 μm for SiGe. The waveguide obtained in FIG. 11B is a flat waveguide, called 2D guide, which extends over the whole surface of the substrate 10b.

A sealing line 105 made of gold Au is then defined and produced by deposition/lithography/etching steps, at the periphery of the waveguide wafer. This sealing line 105 then makes it possible for the assembly of the mirror and waveguide wafers.

Extraction zones 313 intended to house the extraction structures 311 during the assembly, are then defined by lithography/etching (FIG. 11D).

Mirror and waveguide wafers are then assembled. An assembly by Au—Au thermocompression, is preferably used. Metal-metal thermocompression has the advantage, further to its relatively simple and inexpensive implementation, to be done at a low temperature (<400° C.), typically around 250° C. Other assembly techniques are also possible (eutectic gluing, direct gluing, polymer gluing, etc.). The alignment tolerances for this type of assembly by thermocompression are about a few microns, typically +/−5 μm.

After assembly, a thinning of the waveguide wafer is preferably done, from the face 103 such as illustrated in FIG. 9A. The substrate 10b has, after thinning, a thickness, preferably less than or equal to 300 μm. This ultimately makes it possible to reduce the distance between the surface of the sample to be analysed and the sensor.

The wafer resulting from the assembly can be cut into several photonic chips.

The invention is not limited to the embodiments described, but extends to any embodiment entering into the scope of claim 1.

1. A lens-free infrared imaging device intended to image a sample, comprising:
at least one light source configured to emit a light according to several wavelengths of the infrared range, said at least one light source having an emission face intended to emit the light in the direction of the sample to be imaged,
said device further comprising at least one sensor configured to detect a reflective part of the light emitted having interacted with the sample, said sensor comprising a plurality of pixels and having a detection face intended to receive said reflective part of the light emitted, the emission and detection faces facing one same side of the device,
said at least one light source comprising a primary source configured to emit light according to several wavelengths of the infrared range, coupled with a secondary source configured to reemit said light in a plurality of emission directions, the emission face being located at the secondary source and the primary source being moved outside of an emission zone of the emission face, the device being characterised in that the secondary source is formed at least partially by a photonic chip comprising a plurality of passive extraction structures coupled with the primary source.

2. The lens-free infrared imaging device according to claim 1, wherein the light source and the sensor are stacked on one another.

3. The lens-free infrared imaging device according to claim 1, wherein the light emitters are arranged in the form of an emission matrix and the pixels of the sensor are arranged in the form of a detection matrix, the photonic chip being superposed to the sensor such that the light emitters are alternated with the pixels of the sensor, in projection in a stacking direction (z) of the photonic chip and of the sensor.

4. The lens-free infrared imaging device according to claim 1, wherein the photonic chip is superposed to the sensor and the light emitters surround the pixels of the sensor, in projection in a stacking direction (z) of the photonic chip and of the sensor.

5. The lens-free infrared imaging device according to claim 1, wherein the photonic chip comprises waveguides configured to guide the light emitted by the primary source to the passive extraction structures.

6. The lens-free infrared imaging device according to claim 5, wherein the passive extraction structures each have at least one facet inclined by an angle of between 30° and 60° relative to the emission face, said facets facing the waveguides and configured to reflect the light exiting the waveguides, in the plurality of emission directions, so as to form extraction mirrors.

7. The lens-free infrared imaging device according to claim 1, wherein the photonic chip has a thickness less than or equal to 300 μm, and preferably of between 100 microns and 2 mm.

8. A method for manufacturing a lens-free infrared imaging device according to claim 1, comprising the following steps:
providing a primary light source,
forming the photonic chip intended to reemit, at an emission face, the light emitted by the primary source,
providing a sensor comprising a plurality of pixels capable of detecting, on a detection face, some of the light emitted by the primary light source,
assembling the photonic chip to the sensor such that the emission and detection faces face one same side of the device,
coupling the primary light source to the passive extraction structures of the photonic chip (30).

9. The manufacturing method according to claim 8, wherein the formation of the photonic chip comprises:
forming the passive extraction structures protruding from a first face of a first silicon-based substrate), by etching said substrate,
forming waveguides facing extraction structures, said waveguides being configured to guide the light emitted by the primary light source (3a) to the extraction structures.

10. The manufacturing method according to claim 9, wherein the waveguides are formed directly on the first face of the first silicon-based substrate, in at least one layer made of a material different from silicon, and wherein the passive extraction structures are formed in said at least one layer.

11. The manufacturing method according to claim 9, wherein the waveguides are formed on a second face of a second substrate, and wherein the second substrate is assembled to the first substrate, such that the waveguides are facing the extraction structures of the first substrate, the method further comprising a thinning of the second substrate from a face opposite the second face.

12. The manufacturing method according to claim 9, wherein the passive extraction structures are etched so as to each have at least one facet inclined by an angle of between 30° and 60° relative to the first face, and wherein a metal deposition is performed on each of said at least one facet, so as to form extraction mirrors.

13. A method for using a device according to claim 1, wherein the device is in contact with or in the immediate proximity of a zone to be imaged of the sample, such that the distance separating said zone to be imaged and the sensor is less than 200 μm.
